(19) United States
(12) Patent Application Publication
(10) Pub. No.: US 2013/0148617 A1
(43) Pub. Date: Jun. 13, 2013

(54) DEVICE AND METHOD FOR TRANSMITTING CONTROL INFORMATION IN MULTI-CARRIER SYSTEM

(71) Applicants: Dong Hyun Park, Seoul (KR); Ki Tae Kim, Seoul (KR)

(72) Inventors: Dong Hyun Park, Seoul (KR); Ki Tae Kim, Seoul (KR)

(73) Assignee: Pantech Co., Ltd., Seoul (KR)

(21) Appl. No.: 13/817,365

(22) PCT Filed: Aug. 10, 2011
(86) PCT No.: PCT/KR11/05859

§ 371 Date: Feb. 15, 2013

(30) Foreign Application Priority Data
Aug. 16, 2010 (KR) 10-2010-0079020

(51) Int. Cl. H04W 72/04

(52) U.S. Cl. CPC H04W 72/0413
USPC 370/329

(57) ABSTRACT

Disclosed are a transmission device and method, and a receiving device and method of control information by a terminal in a multi-component carrier system. The present invention provides the method comprising: receiving on a component carrier a PDCCH that explicitly indicates a resource index of a PUCCH; receiving on said component carrier a PDSCH that is indicated by said PDCCH; calculating a cyclic shift sequence and an orthogonal sequence on the basis of said resource index; spreading to said cyclic shift sequence and said orthogonal sequence an ACK/NACK signal that indicates successful reception or unsuccessful reception of said PDSCH; mapping said spread ACK/NACK signal into said PUCCH; and transmitting said PUCCH to a base station. The invention can resolve the problem of resource indexes of uplink control channels colliding with each other. Thus, reliability of the transmission of control information is improved.

### CROSS-REFERENCE TO RELATED APPLICATIONS

This application is the National Stage Entry of International Application No. PCT/KR2011/005859, filed on Aug. 10, 2011, and claims priority from and the benefit of Korean Patent Application No. 10-2010-0079020, filed on Aug. 16, 2010, both of which are hereby incorporated by reference for all purposes in their entirety as if fully set forth herein

### BACKGROUND

1. Field

The present invention relates to wireless communication and, more particularly, to a wireless communication system supporting multiple carriers.

2. Discussion of Background

In general, a wireless communication system uses a single bandwidth to transmit data. For example, a 2^{nd}-generation wireless communication system uses a bandwidth of 200 KHz to 1.25 MHz, and a 3^{rd}-generation wireless communication system uses a bandwidth of 5 MHz to 10 MHz. In order to support increasing transmission capacity, recent LTE (Long Term Evolution) of 3GPP (3rd Generation Partnership Project) or IEEE 802.16m continues to extend a bandwidth to 20 MHz or higher. In order to increase transmission capacity, it may be essential to extend bandwidth but frequency assignment of a large bandwidth is not easy except for some areas in the world.

In order to effectively use a fragmented small bandwidth, a carrier aggregation (CA) technique of groping a plurality of physically non-continuous bands to obtain an effect as if a logically large band is used in a frequency domain has been developed. An individual unit carrier grouped for CA is known as a component carrier (CC). Each CC is defined by a single bandwidth and a center frequency. A system allowing data to be transmitted and/or received in a broadband through a plurality of CCs is known as a multi-component carrier system. The multi-CC system supports both a narrow band and a wide band by using one or more CCs. For example, when a single carrier corresponds to a bandwidth of 5 MHz, a maximum 20 MHz bandwidth may be supported by using four carriers.

In order to operate a multi-CC system, various control signals are required between a base station and a mobile station. For example, ACK (Acknowledgement)/NACK (Not-Acknowledgement) for performing HARQ (hybrid automatic repeat request), a CQI (Channel Quality Indicator), and the like, are required to be exchanged. However, since the multi-CC system uses multiple uplink CCs and multiple downlink CCs, a device and method for exchanging various types of control signaling between a base station and a mobile station are required in such a communication environment.

### SUMMARY

An aspect of the present invention provides a device for transmitting control information in a multi-component carrier system.

Another aspect of the present invention provides a method for transmitting control information in a multi-component carrier system.

Still another aspect of the present invention provides a device for receiving control information in a multi-component carrier system.

Yet another aspect of the present invention provides a method for receiving control information in a multi-component carrier system.

According to an aspect of the present invention, there is provided a method for transmitting control information by a mobile station in a multi-component carrier system. This method includes receiving a physical downlink control channel (PDCCH) and a physical downlink shared channel (PDSCH) indicated by the PDCCH from a base station; configuring a physical uplink control channel (PUCCH) carrying an ACK/NACK signal indicating whether the PDSCH has been successfully received or unsuccessfully received; and transmitting the ACK/NACK signal on the PUCCH.

The PUCCH is configured based on a resource index, and the resource index may be determined based on an offset value set to be different for each component carrier.

According to another aspect of the present invention, there is provided a method for receiving control information by a base station in a multi-component carrier system. This method includes: transmitting a PDCCH and a PDSCH indicated by the PDDDH to a mobile station; and receiving an ACK/NACK signal indicating whether the PDSCH has been successfully or unsuccessfully received, on the PUCCH from the mobile terminal.

The PUCCH may be configured based on a resource index, and the resource index may be determined based on an offset value set to be different for each component carrier.

According to another aspect of the present invention, there is provided a device for transmitting control information in a multi-component carrier system. The device may include: a physical channel reception unit configured to receive a PDCCH of a component carrier and a PDSCH indicated by the PDCCH from a base station; a resource index allocation unit configured to calculate a resource index of a PUCCH corresponding to the PDSCH based on an offset value specifically set for the component carrier, and allocating the calculated resource index to transmission of the PUSCH; a channel configuration unit configured to configure an ACK/NACK channel carrying an ACK/NACK signal with respect to the PDSCH; and an ACK/NACK channel transmission unit configured to transmit the ACK/NACK signal to the base station via the ACK/NACK channel.

According to another aspect of the present invention, there is provided a device for receiving control information in a multi-component carrier system. The reception device may include: a physical channel transmission unit configured to transmit a PDCCH of a component carrier and a PDSCH indicated by the PDCCH; and an ACK/NACK channel reception unit configured to receive an ACK/NACK signal indicating whether the PDSCH has been successfully or unsuccessfully received via an ACK/NACK channel. Resource of the ACK/NACK channel may be determined by a resource index, and the resource index may be calculated based on an offset value specifically set for the component carrier.

According to another aspect of the present invention, there is provided a method for transmitting control information by a mobile station in a multi-component carrier system. The method may include: receiving a physical downlink control channel explicitly indicating a resource index of a physical uplink control channel, on a component carrier; receiving a physical downlink shared channel indicated by the physical downlink control channel, on the component carrier; calculating a cyclically shifted sequence and an orthogonal sequence based on the resource index; spreading an ACK/NACK signal indicating whether the physical downlink shared channel has been successfully or unsuccessfully received, by the cyclically shifted sequence and the orthogonal sequence; mapping the spread ACK/NACK signal to the physical uplink control channel; and transmitting the physical uplink control channel to a base station.

According to another aspect of the present invention, there is provided a method for receiving control information by a base station in a multi-component carrier system. The method includes: transmitting a physical downlink control channel explicitly indicating a resource index of a physical uplink control channel, on a component carrier, to a mobile station; transmitting a physical downlink shared channel indicated by the physical downlink control channel, on the component carrier, to the mobile station; and receiving the physical uplink control channel from the mobile station.

An ACK/NACK signal indicating whether the physical downlink shared channel has been successfully or unsuccessfully received may be mapped to the physical uplink control channel. The ACK/NACK signal may be spread by a cyclically shifted sequence and an orthogonal sequence calculated based on the resource index.

According to another aspect of the present invention, there is provided a mobile station for transmitting control information in a multi-component carrier system. The mobile station includes: a physical channel reception unit configured to receive a physical downlink control channel explicitly indicating a resource index of a physical uplink control channel and a physical downlink shared channel indicated by the physical downlink control channel, on a component carrier; a resource index allocation unit configured to allocate the resource index corresponding to the physical downlink common channel; an ACK/NACK channel configuration unit configured to spread an ACK/NACK signal indicating whether the physical downlink shared channel has been successfully or unsuccessfully received, by a cyclically shifted sequence and an orthogonal sequence calculated based on the resource index; and an ACK/NACK channel transmission unit configured to map the spread ACK/NACK signal to the physical uplink control channel and transmit the same.

According to embodiments of the present invention, in a communication environment in which different downlink component carriers share an uplink control channel of the same uplink component carrier, a collision of resource indexes of uplink control channels can be solved by setting an offset value, such as a renumbering offset value, a division offset value, or the like, specific to for each component carrier. Thus, reliability of transmission of control information can be enhanced.

### BRIEF DESCRIPTION OF THE DRAWINGS

FIG. 1 is a view illustrating a wireless communication system.

FIG. 2 is a view illustrating an example of a protocol structure for supporting multiple carriers.

FIG. 3 is a view illustrating an example of a frame structure for a multi-carrier operation.

FIG. 4 is a view illustrating a linkage between a downlink component carrier and an uplink component carrier in a multi-carrier system.

FIG. 5 is a view illustrating downlink HARQ and CQI transmission.

FIG. 6 is a view illustrating an example of a structure of an uplink subframe carrying an ACK/NACK signal.

FIG. 7 is a view illustrating transmission of an ACK/NACK signal on a PUCCH.

FIG. 8 is a view illustrating an example of mapping a PUCCH to physical RBs.

FIG. 9 is a conceptual view illustrating a scenario in which resources of an ACK/NACK signal collides in the multi-carrier system.

FIG. 10 is a flow chart illustrating a method for transmitting an ACK/NACK signal in the multi-component carrier system.

FIG. 11 is a view illustrating a situation in which collision of resources of an ACK/NACK signal is avoided by the method for transmitting an ACK/NACK signal in FIG. 10.

FIG. 12 is a flow chart illustrating a method for transmitting an ACK/NACK signal in the multi-component carrier system according to another embodiment of the present invention.

FIG. 13 is a view illustrating a concept of renumbering a CCE number.

FIG. 14 is a flow chart illustrating a method for transmitting an ACK/NACK signal in the multi-component carrier system according to another embodiment of the present invention.

FIG. 15 is a flow chart illustrating a method for transmitting an ACK/NACK signal in the multi-component carrier system according to another embodiment of the present invention.

FIG. 16 is a view illustrating a resource index for each DL CC allocated by divisional resource allocation.

FIG. 17 is a block diagram illustrating a transmission device and a reception device of an ACK/NACK signal in the multi-component carrier system according to an embodiment of the present invention.

### DETAILED DESCRIPTION OF ILLUSTRATED EMBODIMENTS

The embodiments of the present invention will now be described with reference to the accompanying drawings, in which like numbers refer to like elements throughout although they are shown in different drawings. In describing the present invention, if a detailed explanation for a related known function or construction is considered to unnecessarily divert the gist of the present invention, such explanation will be omitted but would be understood by those skilled in the art.

In describing the elements of the present invention, terms such as first, second, A, B, (a), (b), etc., may be used. Such terms are used for merely discriminating the corresponding elements from other elements and the corresponding elements are not limited in their essence, sequence, or precedence by the terms. It will be understood that when an element or layer is referred to as being “on” or “connected to” another element or layer, it can be directly on or directly connected to the other element or layer, or intervening elements or layers may be present.

In the present disclosure, a wireless communication network will be described, and an operation performed in the wireless communication network may be performed in a process of controlling a network and transmitting data by a system (e.g., a base station (BS)) administering the corresponding wireless communication network or may be performed in a mobile station (MS) connected to the corresponding wireless network.

According to embodiments of the present invention, “transmitting a control channel” may be interpreted as having a meaning of transmitting control information via a particular channel. Here, a control channel may be a physical downlink control channel (PDCCH) or a physical uplink control channel (PUCCH).

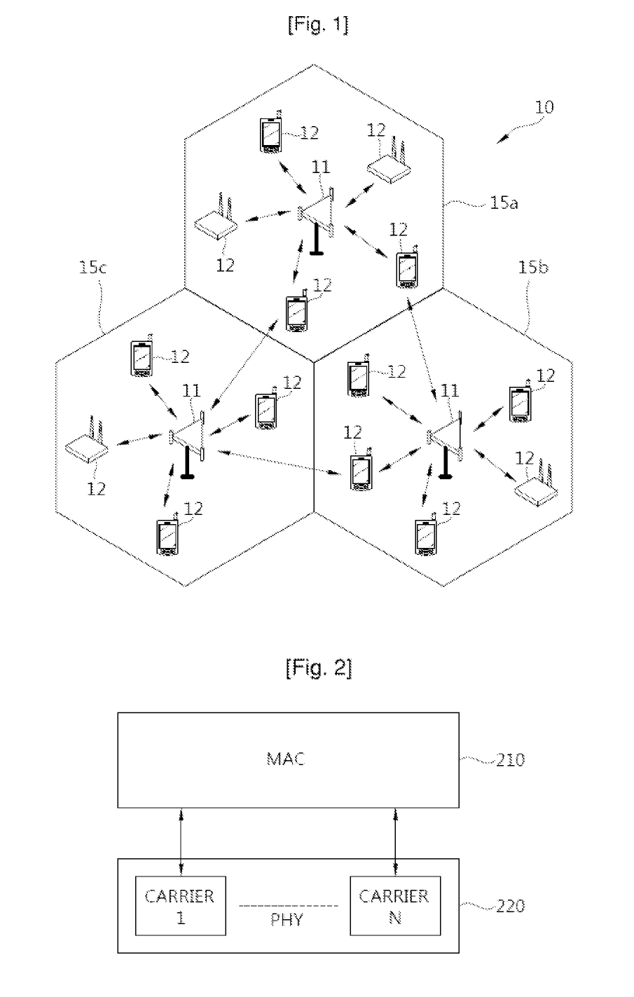

FIG. 1 is a view illustrating a wireless communication system.

Referring to FIG. 1, a wireless communication system 10 is widely disposed to provide various communication services such as voice and packet data, or the like. The wireless communication system 10 includes at least one base station (BS). Each BS 11 provides a communication service to particular geographical areas or frequency areas (which is generally called cells) 15a, 15b, and 15c. The cells may be divided into a plurality of areas (which is generally called sectors).

A mobile station (MS) 12 may be fixed or mobile and may be referred to by other names such as user equipment (UE), mobile terminal (MT), user terminal (UT), subscriber station (SS), wireless device, personal digital assistant (PDA), wireless modem, handheld device, etc. The BS 11 generally refers to a fixed station that communicates with the MS 12 and may be called by other names such as evolved-node B (eNB), base transceiver system (BTS), access point (AP), a femto BS, a home nodeB, a relay, a remote radio head (RRH), etc. Cells 15a, 15b, and 15c may be construed to have comprehensive meanings indicating partial areas covered by the BS 11, and may include various coverage areas such as a mega-cell, a macro-cell, a micro-cell, a pico-cell, a femto-cell, and the like.

Hereinafter, downlink (DL) refers to communication from the BS 11 to the MS 12, and uplink (UL) refers to communication from the MS 12 to the BS 11. In the downlink, a transmitter may be a part of the BS 11 and a receiver may be a part of the MS 12. In the uplink, a transmitter may be a part of the MS 12 and a receiver may be a part of the BS 11. Multi-access schemes applied to the wireless communication system are not limited. Namely, various multi-access schemes such as CDMA Code Division Multiple Access), TDMA (Time Division Multiple Access), FDMA (Frequency Division Multiple Access), OFDMA (Orthogonal Frequency Division Multiple Access), SC-FDMA (Single Carrier-FDMA), OFDM-FDMA, OFDM-TDMA, OFDM-CDMA, or the like, may be used. For uplink transmission and downlink transmission, a TDD (Time Division Duplex) scheme in which transmission is made by using a different time or an FDD (Frequency Division Duplex) scheme in which transmission is made by using different frequencies may be used.

A carrier aggregation (CA) supports a plurality of carriers, which is also called a spectrum aggregation or a bandwidth aggregation. Carrier aggregation is introduced to support increased throughput, prevent an increase in cost otherwise caused by an introduction of a broadband radio frequency (RF) element, and guarantee compatibility with an existing system. For example, when five component carriers are allocated as granularity of carrier unit having a 5 MHz bandwidth, a maximum 25 MHz bandwidth can be supported.

The carrier aggregation can be divided into a contiguous carrier aggregation made among component carriers consecutive in a frequency domain and a non-contiguous carrier aggregation made among component carriers inconsecutive the frequency domain. An aggregation in which the number of downlink component carriers is equal to the number of uplink component carriers is called a symmetric aggregation, and an aggregation in which the number of downlink component carriers is equal to the number of uplink component carriers is called an asymmetric aggregation.

Sizes (i.e., bandwidths) of component carriers may vary. For example, when five component carriers are used to configure a 70 MHz band, the five carriers may be configured as follows: 5 MHz carrier (carrier #0)+20 MHz carrier (carrier #1)+20 MHz carrier (carrier #2)+20 MHz carrier (carrier #3)+5 MHz carrier (carrier #4).

Hereinafter, a multi-carrier system refers to a system supporting the carrier aggregation. In the multi-carrier system, the contiguous carrier aggregation and/or a non-contiguous carrier aggregation may be used, or any of the symmetrical aggregation and the asymmetrical aggregation may be used.

FIG. 2 shows an example of a protocol structure for supporting multiple carriers.

Referring to FIG. 2, a common medium access control (MAC) entity 210 manages a physical (PHY) layer 220 using a plurality of carriers. A MAC management message transmitted in a particular carrier may be applied to a different carrier. Namely, the MAC management message, including a particular carrier, can control other carriers. The PHY layer 220 may operate according to TDD (Time Division Duplex) and/or FDD (Frequency Division Duplex).

Some physical control channels are used in the PHY layer 220. A PDCCH (physical downlink control channel) allocates resources of PCH (paging channel) and DL-SCH (downlink shared channel) to the MS and provides in HARQ (hybrid automatic repeat request) information related to a DL-SCH. The PDCCH may carry an uplink grant informing the MS about a resource allocation of uplink transmission and a downlink grant informing the MS about resource allocation of downlink transmission. A PCFICH (physical control format indicator channel) is a physical channel transmitting a format of a PDCCH, i.e., a format indicator indicating a number of OFDM symbols constituting the PDCCH, to the MS, which is included in every subframe. The format indicator may also be called a control format indicator (CFI).

A PHICH (physical Hybrid ARQ Indicator Channel), a response to an uplink transmission, carries an HARQ ACK/NAK signal. A PUCCH (Physical uplink control channel) carries a HARQ ACK/NAK signal with respect to a downlink transmission, a scheduling request, a sounding reference signal (SRS), and uplink control information such as CQI, or the like. A PUSCH (Physical uplink shared channel) carries an UL-SCH (uplink shared channel).

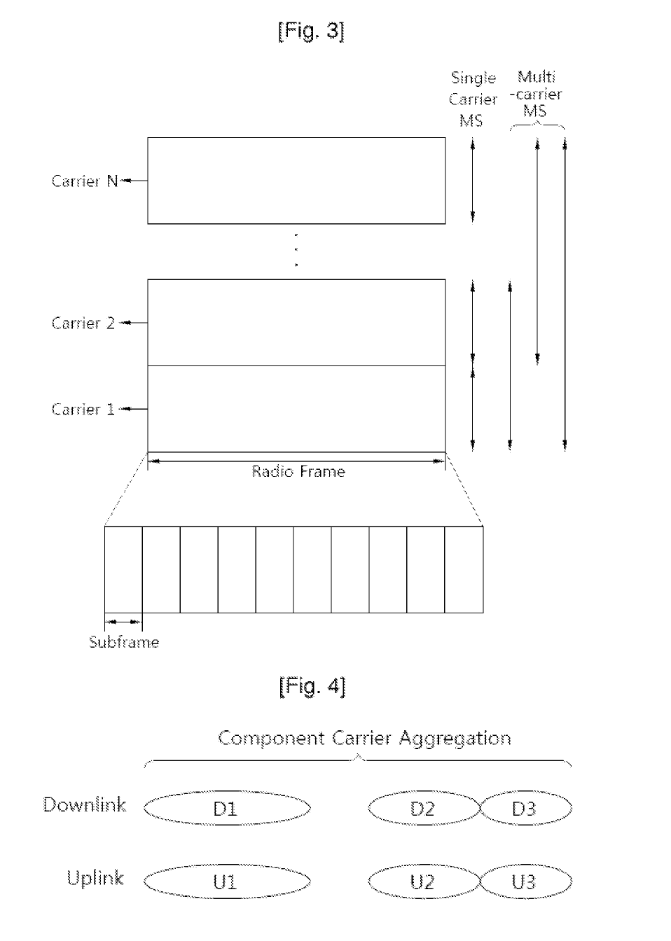

FIG. 3 illustrates an example of a frame structure for operating multiple carriers.

Referring to FIG. 3, a frame includes 10 subframes. Each of the subframes a plurality of OFDM symbols. Each carrier may have its own control channel (e.g., a PDCCH). Multiple carriers may be adjacent to each other or may not. The MS may support one or more carriers according to its capability.

Component carriers may be divided into a primary component carrier (PCC) and a secondary component carrier (SCC) depending on whether or not they are activated. Here, activation refers to a state in which traffic data is transmitted or received or a state in which traffic data is ready to be transmitted or received. Deactivation refers to a state in which traffic data cannot be transmitted or received and measurement or transmission or reception of minimum information is available. The MS may use only one primary component carrier or one or more secondary component carriers along with a primary component carrier. The MS may be allocated the primary component carrier and/or the secondary component carrier from the BS.

FIG. 4 illustrates a linkage between downlink component carriers and uplink component carriers in the multi-carrier system.

Referring to FIG. 4, downlink component carriers D1, D2, and D3 are aggregated in downlink, and uplink component carriers U1, U2, and U3 are aggregated in uplink. Here, Di is an index (i=1, 2, 3) of the downlink component carriers, and Ui is an index of uplink component carriers. At least one downlink component carrier is a primary component carrier, and the other remaining downlink carriers are secondary component carriers. Similarly, at least one uplink component carrier is a primary component carrier, and the other remaining uplink carriers are secondary component carriers. For example, D1 and U1 are primary component carriers, and D2, U2, D3, and U3 are secondary component carriers.

In an FDD system, the downlink component carriers and the uplink component carriers are set to be connected by 1:1, and in this case, D1 is set to be connected to U1, D2 to U2, and D3 to U3, in a one-to-one manner. The MS sets the connection between the downlink component carriers and the uplink component carriers through system information transmitted by a logical channel BCCH or an MS-dedicated RRC message transmitted by a DCCH. Each connection may be set to be specific to a cell or may be specific to an MS.

A primary serving cell refers to a serving cell providing a security input and NAS mobility information in a state in which an RRC is established or re-established. At least one cell may be configured to form a set of serving cells along with a primary serving cell according to capabilities of the MS, and in this case, the at least one cell is called a secondary service cell. Thus, the set of the serving cells configured for one MS may include only a single primary serving cell or may include one primary serving cell and at least one secondary serving cell. A downlink component carrier corresponding to a primary serving cell is called a downlink primary component carrier (DL PCC), and an uplink component carrier corresponding to a primary serving cell is called an uplink primary component carrier (UL PCC).

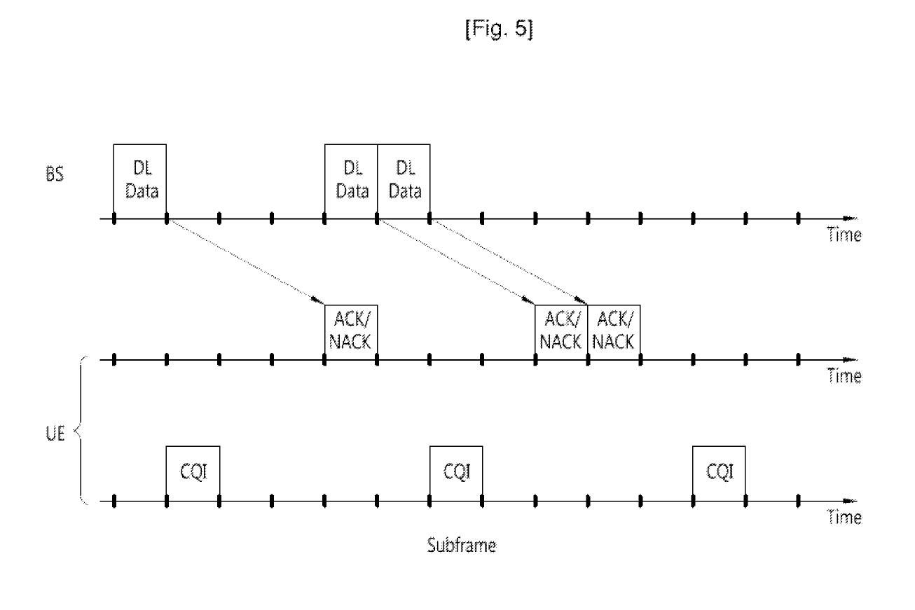

FIG. 5 is a view illustrating downlink HARQ and CQI transmission.

Referring to FIG. 5, when an MS receives downlink data (DL data) from a BS, it transmits an ACK (Acknowledgement)/NACK (Not-Acknowledgement) signal after a certain time has lapsed. Downlink data may be transmitted on a PDSCH indicated by a PDCCH. When the downlink data is successfully decoded, the ACK/NACK signal may be an ACK signal, and when decoding of the downlink data fails, the ACK/NACK signal is a NACK signal. When the BS receives the NACK signal, the BS may retransmit the downlink data up to a maximum retransmission number.

A transmission time of the ACK/NACK signal or resource allocation with respect to the downlink data may be dynamically informed by the BS through signaling, or may be previously agreed according to the downlink data transmission time or the resource allocation.

The MS may measure a downlink channel state and periodically and/or aperiodically report a CQI to the BS. The BS may provide a transmission timing of the CQI or resource allocation to the MS.

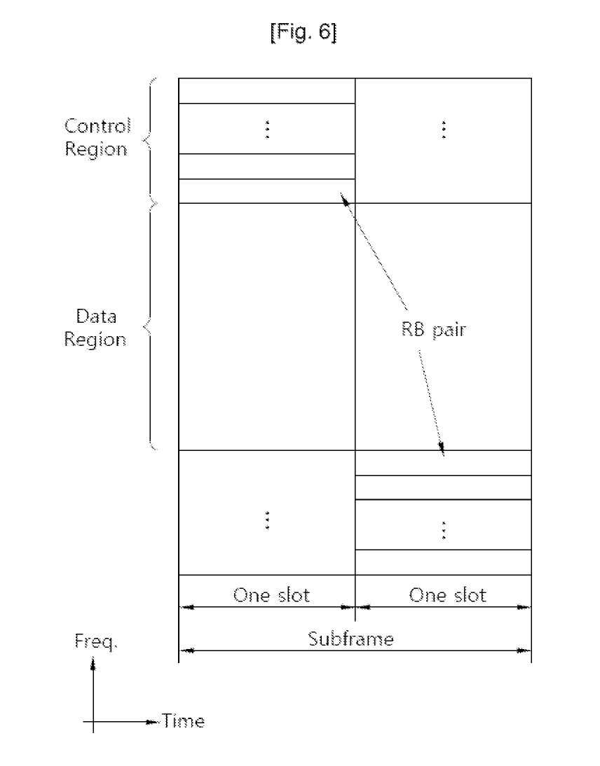

FIG. 6 is a view illustrating an example of a structure of an uplink subframe carrying an ACK/NACK signal.

Referring to FIG. 6, an uplink subframe may be divided into a control region to which a physical uplink control channel (PUCCH) that carries uplink control information is allocated and a data region to which physical uplink shared channel (PUSCH) that carries user data is allocated in the frequency domain. In case of a single carrier-FDMA (SC-FDMA), an MS does not transmit a PUCCH and a PUSCH simultaneously in order to maintain single carrier characteristics.

In the subframe, a pair of RBs are allocated to the PUCCH with respect to one MS, and the allocated resource block (RB) pair are resource blocks corresponding to different subcarriers in each of two slots. This is called that the RB pair allocated to the PUCCH are frequency-hopped at a slot boundary.

The PUCCH may support multiple formats. Namely, it can transmit uplink control information having different number of bits per subframe according to a modulation scheme. Table 1 below shows modulation schemes and number of bits according to various PUCCH formats.

TABLE 1

| PUCCH | Modulation | Number of bits per |
|---|---|---|
| format | scheme | subframe, M_{bit} |
| 1 | N/A | N/A |
| 1a | BPSK | 1 |
| 1b | QPSK | 2 |
| 2 | QPSK | 20 |
| 2a | QPSK + BPSK | 21 |
| 2b | QPSK + QPSK | 22 |

PUCCH format 1 is used to transmit a scheduling request (SR), and PUCCH format 1a/1b is used to transmit an HARQ ACK/NACK signal. PUCCH format 2 is used to transmit a CQI, and PUCCH format 2a/2b is used to transmit a CQI and a HARQ ACK/NACK. When an HARQ ACK/NACK is transmitted alone, PUCCH format 1a/1b is used, and when an SR is transmitted alone, PUCCH format 1 is used.

Control information transmitted on a PUCCH uses a cyclically shifted sequence. The cyclically shifted sequence is obtained by cyclically shifting a base sequence by a particular cyclic shift (CS) amount.

When one resource block includes 12 subcarriers, a sequence having a length of 12 as expressed by Equation 1 shown below is used as a base sequence.

rᵢ(n)=e^{jb(n)π/4} [Equation 1]

Here, iε{0, 1, . . . , 29} is a root index, n is a component index, 0≦n≦N−1, and N is a length of the sequence. A different base sequence is defined according to a different root index. In case of N=12, b(n) is defined as shown in Table 2 below.

TABLE 2

| i | b(0), . . . , b(11) | | | | | | | | | | | |
|---|---|---|---|---|---|---|---|---|---|---|---|---|
| 0 | −1 | 1 | 3 | −3 | 3 | 3 | 1 | 1 | 3 | 1 | −3 | 3 |
| 1 | 1 | 1 | 3 | 3 | 3 | −1 | 1 | −3 | −3 | 1 | −3 | 3 |
| 2 | 1 | 1 | −3 | −3 | −3 | −1 | −3 | −3 | 1 | −3 | 1 | −1 |
| 3 | −1 | 1 | 1 | 1 | 1 | −1 | −3 | −3 | 1 | −3 | 3 | −1 |
| 4 | −1 | 3 | 1 | −1 | 1 | −1 | −3 | −1 | 1 | −1 | 1 | 3 |
| 5 | 1 | −3 | 3 | −1 | −1 | 1 | 1 | −1 | −1 | 3 | −3 | 1 |
| 6 | −1 | 3 | −3 | −3 | −3 | 3 | 1 | −1 | 3 | 3 | −3 | 1 |
| 7 | −3 | −1 | −1 | −1 | 1 | −3 | 3 | −1 | 1 | −3 | 3 | 1 |
| 8 | 1 | −3 | 3 | 1 | −1 | −1 | −1 | 1 | 1 | 3 | −1 | 1 |
| 9 | 1 | −3 | −1 | 3 | 3 | −1 | −3 | 1 | 1 | 1 | 1 | 1 |
| 10 | −1 | 3 | −1 | 1 | 1 | −3 | −3 | −1 | −3 | −3 | 3 | −1 |
| 11 | 3 | 1 | −1 | −1 | 3 | 3 | −3 | 1 | 3 | 1 | 3 | 3 |
| 12 | 1 | −3 | 1 | 1 | −3 | 1 | 1 | 1 | −3 | −3 | −3 | 1 |
| 13 | 3 | 3 | −3 | 3 | −3 | 1 | 1 | 3 | −1 | −3 | 3 | 3 |
| 14 | −3 | 1 | −1 | −3 | −1 | 3 | 1 | 3 | 3 | 3 | −1 | 1 |
| 15 | 3 | −1 | 1 | −3 | −1 | −1 | 1 | 1 | 3 | 1 | −1 | −3 |
| 16 | 1 | 3 | 1 | −1 | 1 | 3 | 3 | 3 | −1 | −1 | 3 | −1 |
| 17 | −3 | 1 | 1 | 3 | −3 | 3 | −3 | −3 | 3 | 1 | 3 | −1 |
| 18 | −3 | 3 | 1 | 1 | −3 | 1 | −3 | −3 | −1 | −1 | 1 | −3 |
| 19 | −1 | 3 | 1 | 3 | 1 | −1 | −1 | 3 | −3 | −1 | −3 | −1 |
| 20 | −1 | −3 | 1 | 1 | 1 | 1 | 3 | 1 | −1 | 1 | −3 | −1 |
| 21 | −1 | 3 | −1 | 1 | −3 | −3 | −3 | −3 | −3 | 1 | −1 | −3 |
| 22 | 1 | 1 | −3 | −3 | −3 | −3 | −1 | 3 | −3 | 1 | −3 | 3 |
| 23 | 1 | 1 | −1 | −3 | −1 | −3 | 1 | −1 | 1 | 3 | −1 | 1 |
| 24 | 1 | 1 | 3 | 1 | 3 | 3 | −1 | 1 | −1 | −3 | −3 | 1 |
| 25 | 1 | −3 | 3 | 3 | 1 | 3 | 3 | 1 | −3 | −1 | −1 | 3 |
| 26 | 1 | 3 | −3 | −3 | 3 | −3 | 1 | −1 | −1 | 3 | −1 | −3 |
| 27 | −3 | −1 | −3 | −1 | −3 | 3 | 1 | −1 | 1 | 3 | −3 | −3 |
| 28 | −1 | 3 | −3 | 3 | −1 | 3 | 3 | −3 | 3 | 3 | −1 | −1 |
| 29 | 3 | −3 | −3 | −1 | −1 | −3 | −1 | 3 | −3 | 3 | 1 | −1 |

Thus, the base sequence r(n,a) may be cyclically shifted as expressed by Equation 2.

r(n,a)=r((n+a)mod N), for n=0, . . . . ,N−1 [Equation 2]

Here, ‘a’ is the cyclic shift amount, and ‘mod’ is a modulo operation.

FIG. 7 illustrates a state of transmitting an ACK/NACK signal on a PUCCH.

Referring to FIG. 7, reference signals (RSs) are carried in three SC-FDMA symbols among seven SC-FDMA symbols included in one slot, and ACK/NACK signals are carried in the other remaining four SC-FDMA symbols. The RSs are carried in three contiguous SC-FDMA symbols in the middle of the slot.

In order to transmit the ACK/NACK signal, 2-bit ACK/NACK signal is QPSK (Quadrature Phase Shift Keying)-modulated to generate one modulation symbol d(0). Base on the modulation symbol d(0) and the cyclically shifted sequence r(n,a), a modulated sequence y(n) is generated. The following modulated sequence y(n) may be generated by multiplying a modulation symbol to the cyclically shifted sequence r(n,a).

y(n)=d(0)r(n,a) [Equation 3]

The CS amount of the cyclically shifted sequence r(n,a) may be different or the same in each SC-FDMA symbol. Here, 0.1, 2, and 3 are sequentially placed in the CS amount a in the four SC-FDMA symbols in one slot, but it is merely illustrative.

Here, generation of one modulation symbol by QPSK modulating the 2-bit ACK/NACK signal is illustrated, but one modulation symbol may be generated by BPSK (Binary Phase Shift Keying)-modulating 1-bit ACK/NACK signal. The number of bits of the ACK/NACK signal, a modulation scheme, the number of modulation symbols are merely illustrative and do not limit a technical concept of the present invention.

Also, in order to increase terminal capacity, the modulated sequence may be spread by using an orthogonal sequence (OS). As an orthogonal sequence wᵢ(k) (i is a sequence index 0≦k≦K−1) having a spreading factor K=4, the following sequences may be used.

TABLE 3

| Sequence index | [w(0), w(1), w(2), w(3)] |
|---|---|
| 0 | [+1 +1 +1 +1] |
| 1 | [+1 −1 +1 −1] |
| 2 | [+1 −1 −1 +1] |

Alternatively, as an orthogonal sequence wᵢ(k) (I is a sequence index, 0≦k≦K−1) having a spreading coefficient K=3, the following sequences may be used.

TABLE 4

| Sequence index | [w(0), w(1), w(2)] |
|---|---|
| 0 | [1 1 1] |
| 1 | [1 e^{j2π/3} e^{j4π/3}] |
| 2 | [1 e^{j4π/3} e^{j2π/3}] |

Here, it is shown that a sequence modulated through the orthogonal sequence wᵢ(k) having the spreading coefficient K=4 with respect to four SC-FDMA symbols in one slot for the ACK/NACK signal is spread.

The RS may be generated based on a cyclically shifted sequence generated from the same base sequence as that of the ACK/NACK and orthogonal sequence. Namely, the cyclically shifted sequence may be spread through the orthogonal sequence wᵢ(k) having a spreading coefficient K=3 so as to be used as an RS.

A resource index n(1)PUCCH as resource for transmitting PUCCH formats 1/1a/1b is used to determine a CS amount α(nₛ,1) of the base sequence and an orthogonal sequence index n_{OC}(nₛ), as well as a position of a physical resource block in which an A/N signal is transmitted. Resource index n⁽¹⁾_{PUCCH} [symbol] for the HARQ ACK/NAK signal is obtained as shown in Table 5 below. The resource index n⁽¹⁾_{PUCCH} is a parameter for determining a physical RB index n_{PRB}, the CS amount of the base sequence, the orthogonal sequence index n_{OC}(nₛ), and the like.

TABLE 5

| | Dynamic scheduling | Semi-persistent scheduling |
|---|---|---|
| Resource index | n⁽¹⁾_{PUCCH} = n_{CCE} + | Signaled by using higher |
| | N⁽¹⁾_{PUCCH} | layer signaling and control |
| | | channel |
| Higher layer signaling | N⁽¹⁾_{PUCCH} | n⁽¹⁾_{PUCCH} |
| value | | |

Namely, according to the above description, the HARQ ACK/NACK signal with respect to the PDSCH transmitted in the nth subframe is transmitted in the (n+4)th subframe by using the resource index n⁽¹⁾_{PUCCH} as the sum of a first CCE (control channel element) index n_{CCE} of the PDCCH transmitted in the nth subframe and the value N⁽¹⁾_{PUCCH} obtained through higher layer signaling or a control channel. N⁽¹⁾_{PUCCH} is a total number of PUCCH formats 1/1a/1b resources required for semi-persistent scheduling (SPS) transmission. In case of the SPS transmission, since a PDCCH indicating a corresponding PDSCH transmission does not exist, the BS explicitly informs the MS about n⁽¹⁾_{PUCCH}.

The HARQ ACK/NACK signal and/or SR are transmitted through the PUCCH format 1/1a/1b, physical RB index n_{PRB} is determined by the resource index n⁽¹⁾_{PUCCH}. This is as shown in Equation 6 below.

$$[ Equation 6 ]$$

$$m = \{ \begin{matrix}{N}_{RB}^{( 2 )} & if {n}_{PUCCH}^{( 1 )} < c \cdot {N}_{cs}^{( 1 )} / {Δ}_{shift}^{PUCCH} \\ ⌊ \frac{{n}_{PUCCH}^{( 1 )} - c \cdot {N}_{cs}^{( 1 )} / {Δ}_{shift}^{PUCCH}}{c \cdot {N}_{sc}^{RB} / {Δ}_{shift}^{PUCCH}} ⌋ + & otherwise \\ {N}_{RB}^{( 2 )} + ⌈ \frac{{N}_{cs}^{( 1 )}}{8} ⌉ & \end{matrix} \\ c = \{ \begin{matrix}3 & normal cyclic prefix \\ 2 & extended cyclic prefix\end{matrix} \\ {n}_{PRB} = \{ \begin{matrix}⌊ \frac{m}{2} ⌋ & if ( m + {n}_{s} mod 2 ) mod 2 = 0 \\ {N}_{RB}^{UL} - 1 - ⌊ \frac{m}{2} ⌋ & if ( m + {n}_{s} mod 2 ) mod 2 = 1\end{matrix}$$

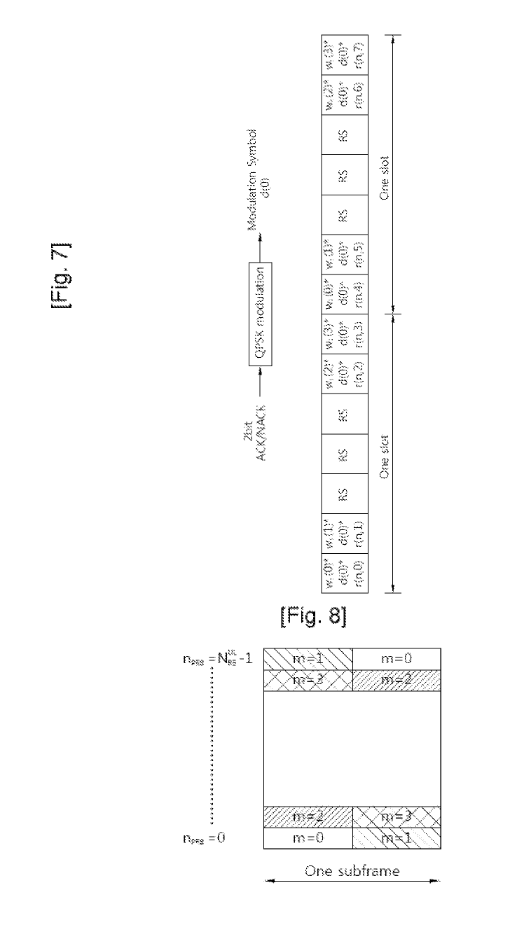

FIG. 8 is a view illustrating an example of mapping a PUCCH to physical RBs. A physical RB index n_{PRB} is determined according to a resource index n⁽¹⁾_{PUCCH}, and a PUCCH corresponding to each m is frequency-hopped by slots.

When a single carrier is used with respect to uplink and downlink, one n_{CCE} is allocated to one PDCCH. When an MS receives a plurality of PDSCHs indicated by different PDCCHs, the MS transmits ACK/NACK signals with respect to the plurality of PDSCHs through different resources based on different n_{CCE}. Thus, the plurality of ACK/NACK signals with respect to different PDSCHs do not collide.

Meanwhile, in case that multiple component carriers are used with respect to uplink and downlink, one n_{CCE} may be allocated to a plurality of PDCCHs. For example, it is assumed that PDSCH1 and PDSCH2 are transmitted through DL CC1 and DL CC2, respectively, and ACK/NACK signal 1 and ACK/NACK signal 2 with respect to the PDSCH1 and PDSCH2 are transmitted through one UL CC1. When n_{CCE} allocated to the PDCCH1 indicating the PDSCH1 and that allocated to PDCCH2 indicating the PDSCH2 are the same, the ACK/NACK signal 1 and the ACK/NACK signal 2 are allocated physical resource according to the same resource index n⁽¹⁾_{PUCCH}. This inevitably causes collision between the resource of the ACK/NACK signal 1 and resource of the ACK/NACK signal 2.

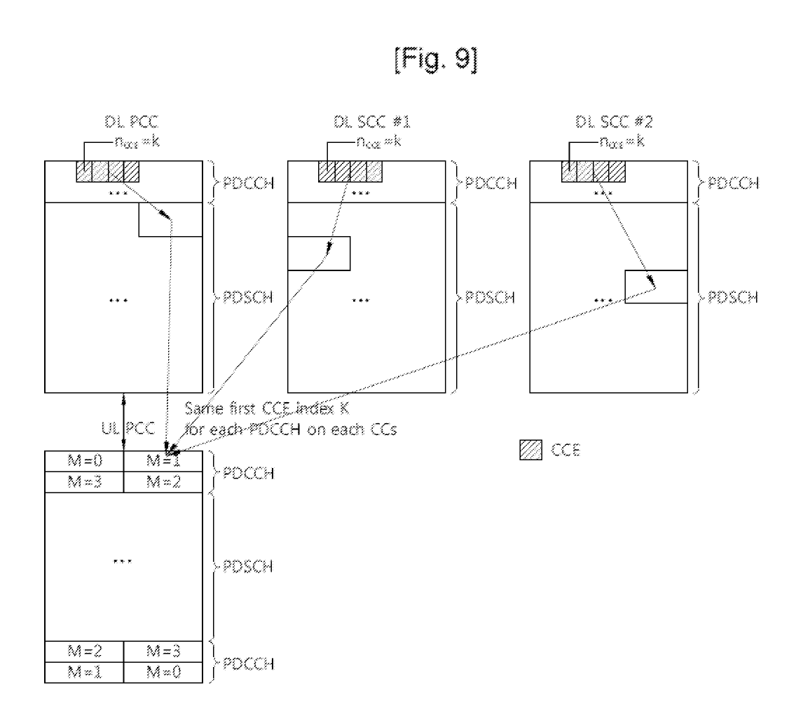

FIG. 9 is a conceptual view illustrating a scenario in which resources of an ACK/NACK signal collides in the multi-carrier system.

Referring to FIG. 9, three DL CCs (DL PCC, DL SCC#1, DL SCC#2) are used in downlink, and one UL CC (UL PCC) is used in uplink. Here, it is assumed that ACK/NACK signals with respect to PDSCHs of three DL CCs are transmitted only through one UL CC.

In case that the PDCCHs transmitted through the three DL CCs use the same first CCE index (n_{CCE}=k) and N⁽¹⁾_{PUCCH} obtained by the respective DL CCs through high layer signaling are the same, the resource index n⁽¹⁾_{PUCCH} for the PUCCH format 1 with respect to the PDSCHs of the respective DL CCs are all the same, causing resource collision. Thus, a device and method for configuring resource index such that ACK/NACK signals with respect to a plurality of PDSCHs in the multi-component carrier system are required.

According to an embodiment of the present invention, in allocating resource of PUCCH format 1/1a/1b for transmission of an ACK/NACK signal, there are an implicit resource allocation, an explicit resource allocation, a hybrid resource allocation, and a divisional resource allocation. Hereinafter, allocation of a resource index according to the respective schemes and a method for transmitting an ACK/NACK signal will be described in detail.

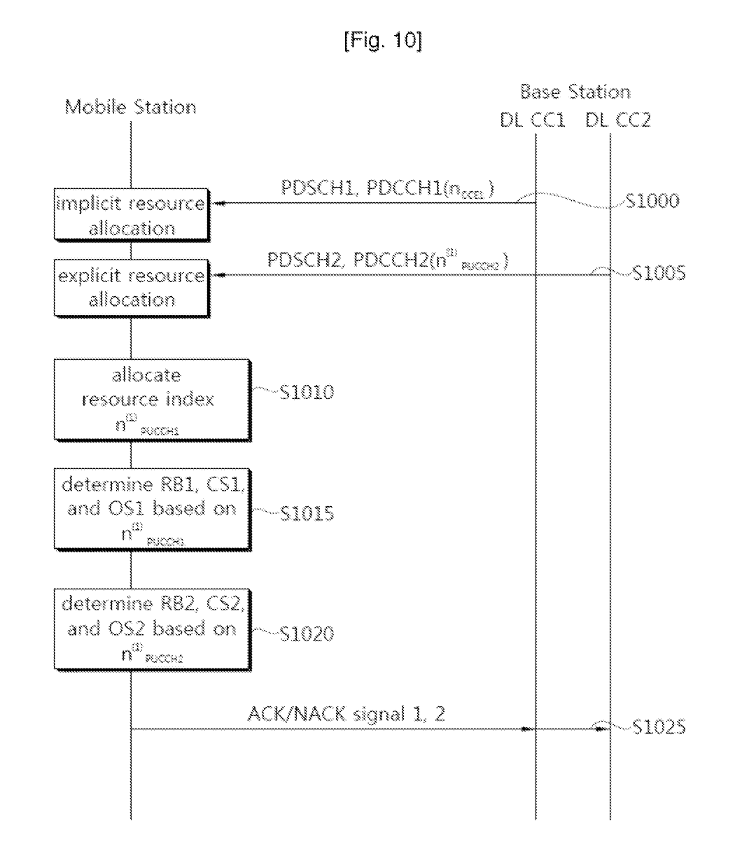

FIG. 10 is a flow chart illustrating a method for transmitting an ACK/NACK signal in the multi-component carrier system.

Referring to FIG. 10, a BS transmits PDCCH1 and PDSCH1 indicated by the PDCCH1 on a DL CC1 in a first subframe to an MS (S1000). The DL CC1 may be a DL PCC or a DL SCC. A number of a first CCE used to transmit PDCCH1 is n_{CCE1}. Also, the BS transmits PDCCH2 explicitly indicating n⁽¹⁾_{PUCCH2} and PDSCH2 indicated by PDCCH2 on DL CC2 in the first subframe (S1005). Hereinafter, n⁽¹⁾_{PUCCH}x refers to a resource index of PUCCH_x of a particular CC. The MS is explicitly allocated a resource index n⁽¹⁾_{PUCCH2} of the PUCCH2 by the BS. The n⁽¹⁾_{PUCCH2} may be received through higher layer signaling or a control channel.

Here, DL CC1 may be a DL PCC, and DL CC2 may be a DL SCC. Conversely, DL CC1 may be a DL SCC, and DL CC2 may be a DL PCC. Alternatively, both DL CC1 and DL CC2 may be DL SCCs.

The MS implicitly allocates the resource index n⁽¹⁾_{PUCCH1} of the PUCCH1 in a second subframe after at least one subframe has lapsed from the first subframe (S1010). Formats of PUCCH1 and PUCCH2 are any one of 1/1a/1b. A method for implicitly allocating the resource index n⁽¹⁾_{PUCCH1} is the same as described above with reference to Table 5.

Implicitly allocating resource index by the BS to the MS refers to allocating resource index of PUCCH regarding a particular MS to the MS by higher layer signal and a control channel without relying on n_{CCE}. Hereinafter, determining a resource index of PUCCH regarding an MS is called an explicit resource allocation. Meanwhile, implicitly allocating resource index refers to allocating resource index calculated by using n_{CCEa} signifying a number of a first CCE among at least one CCE constituting the PDCCH of CC#a, as a parameter. Hereinafter, determining a resource index through such a scheme is called an implicit resource allocation. Also, a scheme of mixing the implicit resource allocation and explicit resource allocation to use the same is called a hybrid resource allocation.

According to the hybrid resource allocation, when two PDSCHs are transmitted via different DL CCs as shown in FIG. 10, a resource index of PUCCH1 regarding the PDSCH1 is implicitly allocated, and resource index of PUCCH2 regarding PDSCH2 is explicitly allocated. Or, resource index of PUCCH regarding PDSCH transmitted through the DL PCC is implicitly allocated, and resource index of PUCCH regarding the PDSCH may be explicitly allocated.

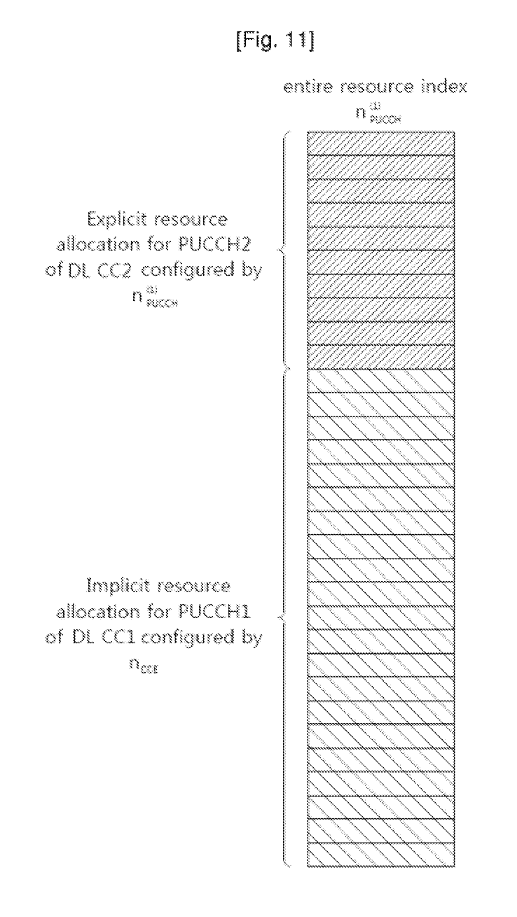

In allocating resource index of PUCCH, when implicit resource allocation is applied to all the DL CCs, the plurality of PDCCHs may use n_{CCE} of the same number of different DL CCs, which may cause collision between resources of ACK/NACK signals. Thus, in order to fundamentally prevent such as resource collision, a hybrid resource allocation may be applied. For example, in a situation in which PDCCH1 is transmitted via DL CC1 and PDCCH2 is transmitted via DL CC2, an implicit resource allocation may be applied to PUCCH1 corresponding to PDCCH1 and an explicit resource allocation may be applied to the PUCCH2 corresponding to PDCCH2. Then, since resource indices do not overlap as shown in FIG. 11, collision between resources of the ACK/NACK signals can be avoided.

Based on the implicitly allocated resource index n⁽¹⁾_{PUCCH}, the MS obtains a physical resource block (RB) 1 for transmitting an ACK/NACK signal 1 indicating whether the PDSCH1 has been successfully received or whether receiving of the PDSCH1 has failed, a cyclic shift (CS) 1 of the ACK/NACK signal, and an orthogonal sequence (OS) value 1, (S1015). Also, based on the explicitly allocated resource index n⁽¹⁾_{PUCCH2}, the MS obtains a physical resource block 2 for transmitting an ACK/NACK signal 2 indicating whether the PDSCH2 has been successfully received or whether receiving of the PDSCH1 has failed, a cyclic shift (CS) 2 of the ACK/NACK signal, and an orthogonal sequence (OS) value 2 (S1020).

Based on the obtained physical resource blocks, the CS values, and the OS values, the MS transmits the ACK/NACK signal1 and the ACK/NACK signal2 to the BS (S1025). Through such a hybrid resource allocation, collision of PUCCH resources and generation of performance degradation can be prevented.

The n⁽¹⁾_{PUCCH2} is allocated within a limit of the PUCCH resource index N⁽¹⁾_{PUCCH} required for transmitting the SPS data and the ACK/NACK signal with respect to the SRI, or N⁽¹⁾_{PUCCH} is increased. In the former case, since PUCCH resource required for transmitting the existing SPS data and the ACK/NACK signal with respect to the SRI is shared, scheduling may be restricted. In the latter case, although the PUCCH resource required for transmitting the existing SPS data and the ACK/NACK signal with respect to the SRI is not shared, a portion of the resource index n⁽¹⁾_{PUCCH} according to the existing implicit resource allocation is changed into N⁽¹⁾_{PUCCH}. Namely, in the hybrid resource allocation, when the amount of explicitly allocated resource index is increased, the amount of implicitly allocated resource index is reduced, and when the amount of explicitly allocated resource index is reduced, the amount of implicitly allocated resource index is increased, having a trade-off relationship.

In FIG. 10, it is assumed that there are only two DL CCs, but this is merely illustrative and two or more DL CCs may exist. Also, FIG. 10 illustrates of an example of the hybrid resource allocation in which implicit resource allocation is applied to the PDCCH1 and explicit resource allocation is applied to the PDCCH2, but explicit resource allocation may be applied to the PDCCH1 and implicit resource allocation may be applied to the PDCCH2

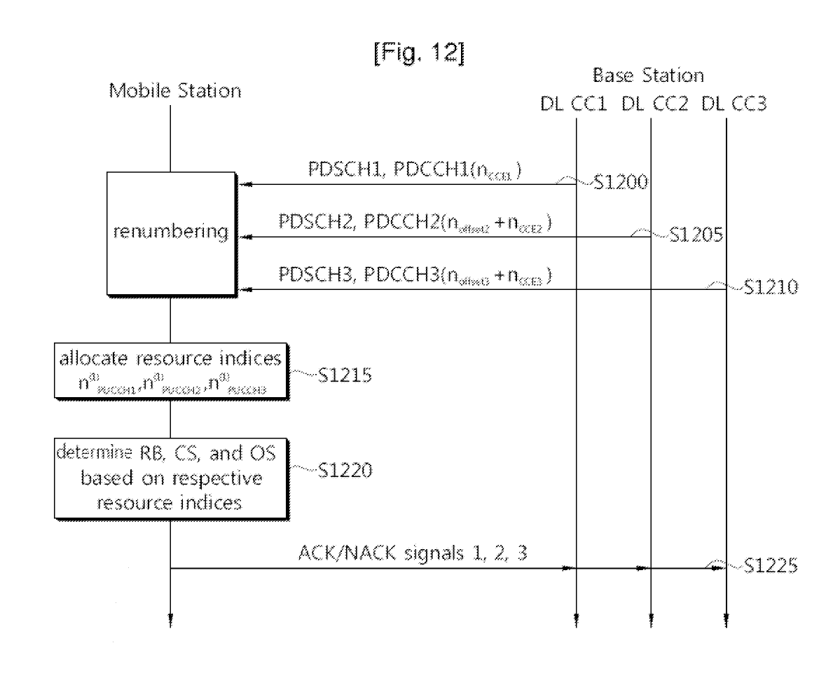

FIG. 12 is a flow chart illustrating a method for transmitting an ACK/NACK signal in the multi-component carrier system according to another embodiment of the present invention.

Referring to FIG. 12, the BS transmits PDCCH1 and PDSCH1 indicated by the PDCCH1 on DL CC1 in a first subframe to the MS (S1200). The DL CC1 may be a DL PCC or a DL SCC. A number of a first CCE used to transmit the PDCCH1 is n_{CCE1}. A resource index regarding PUCCH1 is implicitly allocated by n_{CCE1}.

Also, the BS transmits PDCCH2 and PDSCH2 indicated by the PDCCH2 on DL CC2 in the first subframe (S1205). A number of a first CCE used to transmit PDCCH2 is n_{CCE2}, but the MS uses n′_{CCE2}=n_{offset2}+n_{CCE2} obtained by adding a predetermined offset such that n_{CCE2} does not overlap with n_{CCE1}, to calculate n⁽¹⁾_{PUCCH2}. In this manner, changing of the number of the CCD by adding an offset to the number of CCE constituting the PDCCH of the particular CC in order to prevent a number of CCE constituting PDCCH of particular CC from overlapping with a number of CCD constituting a PDCCH of different CCs is called renumbering.

Also, the BS transmits PDCCH3 and PDSCH 3 indicated by the PDCCH3 on DL CC3 in the first subframe (S1210). The number of the first CCE used to transmit the PDCCH3 is n_{CCE3}, but the MS uses n′_{CCE3}=n_{offset3}+n_{CCE3} obtained by adding a predetermined offset to prevent n_{CCE3} from overlapping with n_{CCE1} and n_{CCE2}, to calculate n⁽¹⁾_{PUCCH3}. Here, n_{offset2} is equal to maximum value of n_{CCE1}+1 and n_{offset3} is equal to maximum value of n_{CCE2}+1.

In this manner, when the CCE numbers of respective DL CCs are renumbered, CCE numbers in different DL CCs do not overlap, and as a result, collision between ACK/NACK signals due to repetition of resource index n⁽¹⁾_{PUCCH} can be prevented. This is no different in case that resource of PUCCH1, PUCCH2, and PUCCH3 corresponding to PDSCH1, PDSCH2, and PDSCH3, respectively, is implicitly allocated by n_{CCE1}, n′_{CCE2}, and n′_{CCE3}. For example, even in case of n_{CCE1}=n_{CCE2}=n_{CCE3}=0, resource index n⁽¹⁾_{PUCCH} is not repeated by n_{offset}.

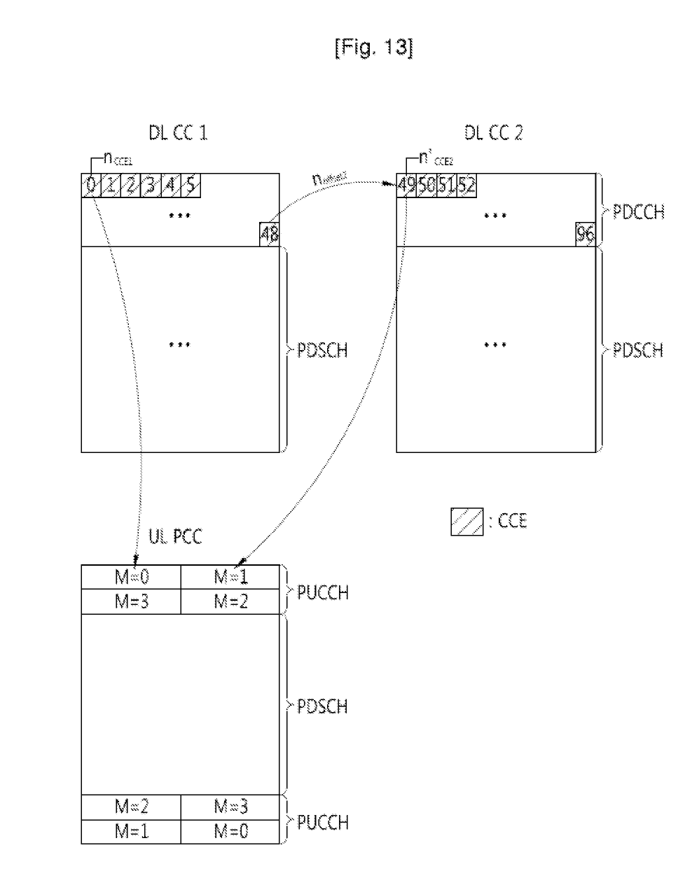

FIG. 13 is a view illustrating a concept of renumbering a CCE number.

Referring to FIG. 13, an MS and a BS perform communication by using DL CC1, DL CC2, and UL PCC.

CCE number x used in PDCCH of DL CC1 has 0, 1, 2, . . . , 48. CCE number y used in PDCCH of DL CC2 has 0, 1, 2, . . . , 48. In case of n_{CCE1}=n_{CCE2}, since resource indices overlap, ACK/NACK signals regarding DL CC1 and DL CC2 collide. Thus, in order to solve this problem, the CCE number y used in the PDCCH of DL CC2 is transformed into y′ through renumbering. Here, y′=n_{offset2}+y and n_{offset2}=max(x)+1=49. Thus, y′ transformed through renumbering has 49, 50, 51, . . . , 96. In this case, since n_{CCE2} is transformed into n′_{CCE2} and n_{CCE1}≠n′_{CCE2}, resource indices do not overlap.

Although n_{CCE1} of the PDCCH of DL CC1 and n′_{CCE2} of the PDCCH of DL CC2 are positioned in the same index, since n_{CCE1}=0 and n′_{CCE2}=49, there is no case in which n_{CCE1} and n′_{CCE2} are the same. In FIG. 13, it is illustrated that by renumbering CCE numbers by using an offset value by DL CCs, resource blocks of PDSCHs indicated by PDCCHs mapped to different CCE numbers and PUCCH resource blocks corresponding to the PDSCHs are different as M=0 and M=1, respectively.

Referring to FIG. 12 the MS allocates resource indices n⁽¹⁾_{PUCCH1}, n⁽¹⁾_{PUCCH2}, and n⁽¹⁾_{PUCCH3} to PUCCH according to implicit resource allocation by n_{CCE1}, n′_{CCE2}, and n′_{CCE3} (S1215). In this case, n⁽¹⁾_{PUCCH1}=n_{CCE1}+N⁽¹⁾_{PUCCH1}, n⁽¹⁾_{PUCCH2}=n′_{CCE2}+N⁽¹⁾_{PUCCH2}=n_{offset2}+n_{CCE2}+N⁽¹⁾_{PUCCH2}, and n⁽¹⁾_{PUCCH3}=n′_{CCE3}+N⁽¹⁾_{PUCCH3}=n_{offset3}+n_{CCE3}+N⁽¹⁾_{PUCCH3}. The PUCCH resource index n⁽¹⁾_{PUCCH} available to be used in one UL CC triples.

The MS determines a resource block (RB), a cyclic shift (CS), and an orthogonal sequence (OS) based on the respective resource indices (S1220). Thereafter, the MS transmits ACK/NACK signals 1, 2, and 3 to the BS based on the RB, CS, and OS (S1225).

Here, any one of three DL CCs may be a DL PCC and the other remaining may be DL SCCs.

In FIG. 12, it is assumed that there are only three DL CCs, but this is merely illustrative and there may be three or more DL CCs. Also, it is described that renumbering is performed in order of PDCCH1→PDCCH2→PDCCH3, but renumbering may be performed in any order.

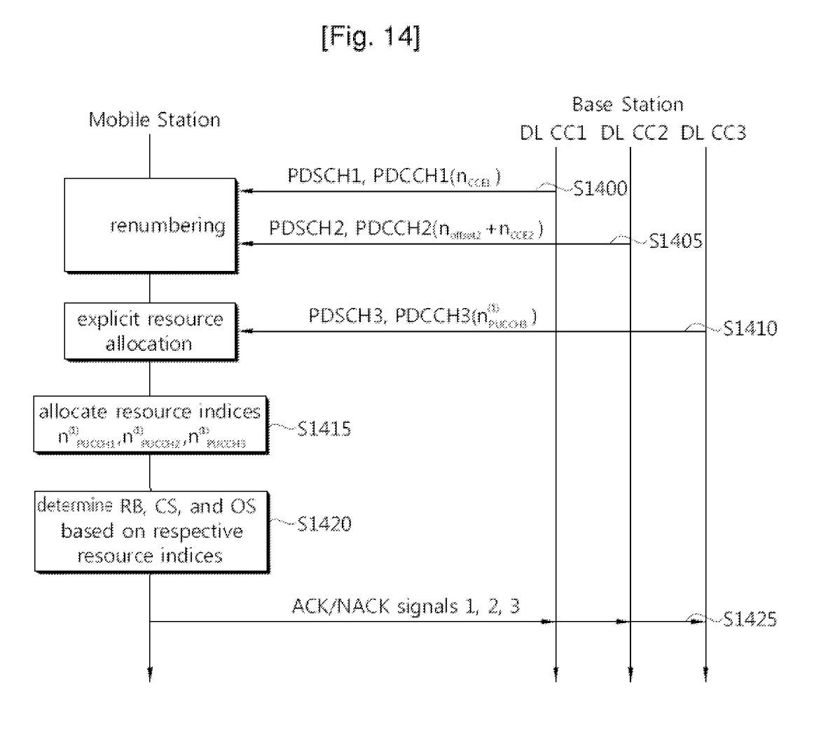

FIG. 14 is a flow chart illustrating a method for transmitting an ACK/NACK signal in the multi-component carrier system according to another embodiment of the present invention. This is a transmission method according to a scheme of allocating resource index n⁽¹⁾_{PUCCH} by employing both the hybrid resource allocation and renumbering. As described above, in the hybrid resource allocation, N⁽¹⁾_{PUCCH} is transformed by higher layer signaling or a control signal, and n_{CCE} is transformed by renumbering.

Referring to FIG. 14, the MS and the BS perform communication by using DL CC1, DL CC2, and UL PCC. The BS transmits PDCCH1 and PDSCH1 indicated by the PDCCH1 on DL CC1 in a first subframe to the MS (S1400). The DL CC1 may be a DL PCC or a DL SCC. A number of a first CCE used to transmit the PDCCH1 is n_{CCE1}. A resource index regarding PUCCH1 is implicitly allocated by n_{CCE1}.

The BS transmits PDCCH2 and PDSCH2 indicated by the PDCCH2 on DL CC2 in the first subframe (S1405). A number of a first CCE used to transmit PDCCH2 is n_{CCE2}, but the MS uses n′_{CCE2}=n_{offset2}+n_{CCE2} obtained by adding a predetermined offset such that n_{CCE2} does not overlap with n_{CCE1}, to calculate n⁽¹⁾_{PUCCH2}. Namely, resource index with respect to PUCCH2 is allocated through renumbering.

Also, the BS transmits PDCCH3 and PDSCH 3 indicated by the PDCCH3 on DL CC3 in the first subframe (S1405). Here, the MS is explicitly allocated resource index n⁽¹⁾_{PUCCH3} from the BS. The n⁽¹⁾_{PUCCH3} may be received by higher layer signaling.

The MS allocates a resource index n⁽¹⁾_{PUCCH1} determined based on n_{CCE1} and resource indices n⁽¹⁾_{PUCCH2} and n⁽¹⁾_{PUCCH3} determined based on n′_{CCE2} as resources of PUCCH1, PUCCH2, and PUCCH3. Here, based on the resource index n⁽¹⁾_{PUCCH1}, resource index n⁽¹⁾_{PUCCH2} is allocated through renumbering and resource index n⁽¹⁾_{PUCCH3} is allocated through hybrid resource allocation. In this case, n⁽¹⁾_{PUCCH1}=n_{CCE1}+N⁽¹⁾_{PUCCH1}, n⁽¹⁾_{PUCCH2}=n′_{CCE2}+N⁽¹⁾_{PUCCH2}=n_{offset2}+n_{CCE2}+N⁽¹⁾_{PUCCH2}, and n⁽¹⁾_{PUCCH3}=n⁽¹⁾_{PUCCH3}.

Since resource indices obtained through renumbering and hybrid resource allocation do not overlap, the MS determines a resource block, a cyclic shift, and an orthogonal sequence based on the corresponding resource indices (S1420). Thereafter, the MS transmits ACK/NACK signals 1, 2, and 3 to the BS by using the resource block, the cyclic shift, and the orthogonal sequence (S1425).

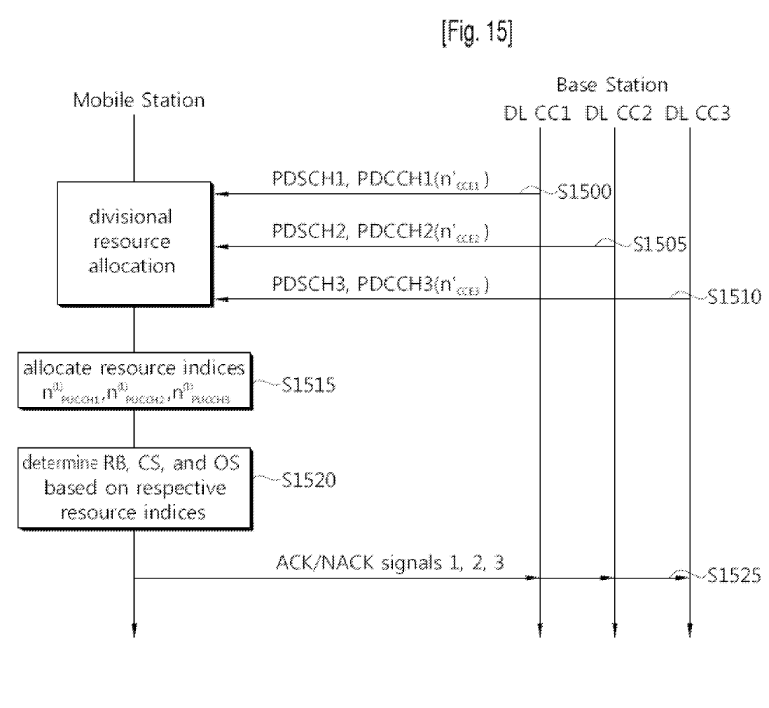

FIG. 15 is a flow chart illustrating a method for transmitting an ACK/NACK signal in the multi-component carrier system according to another embodiment of the present invention. This is a transmission method based on divisional resource allocation in which the entire given resource indices are divided by sections and allocated to respective DL CCs.

In comparison to the hybrid resource allocation in which N⁽¹⁾_{PUCCH} is transformed by higher layer signaling and n_{CCE} is transformed through renumbering, in the divisional resource allocation, the size of n⁽¹⁾_{PUCCH} is maintained as is and n⁽¹⁾_{PUCCH} is allocated only within a predetermined range with respect to respective DL CCs. In this case, when DL CCs are different, n⁽¹⁾_{PUCCH} of different ranges is allocated, so there is no resource collision. In order to implement this, a division offset value is used by DL CCs in the divisional resource allocation.

Referring to FIG. 15, the MS and the BS perform communication by using DL CC1, DL CC2, and UL PCC. The BS transmits PDCCH1 and PDSCH1 indicated by the PDCCH1 on DL CC1 in a first subframe to the MS (S1500). The DL CC1 may be a DL PCC or a DL SCC. A number of a first CCE used to transmit the PDCCH1 is n_{CCE1}. In order to allow only resource index of a first division range to be allocated with respect to DL CC1, the MS uses n′_{CCE1}=n_{CCE1}+N^{CC1}_{PUCCH} obtained by adding a division offset N^{CC1}_{PUCCH} to n_{CCE1}, to calculate a resource index. Here, the resource index is n⁽¹⁾_{PUCCH}=n_{CCE1}+N^{CC1}_{PUCCH}+N⁽¹⁾_{PUCCH}. The division offset is transmitted from the BS to the MS through higher layer signaling.

Also, the BS transmits PDCCH2 and PDSCH2 indicated by the PDCCH2 on DL CC2 in the first subframe (S1505). A number of a first CCE used to transmit PDCCH2 is n_{CCE2}. In order to allow only resource index of a second division range to be allocated with respect to DL CC2, the MS uses n′_{CCE2}=n_{CCE2}+N^{CC2}_{PUCCH} obtained by adding a division offset N^{CC2}_{PUCCH} to n_{CCE2}, to calculate a resource index. Here, the resource index is n⁽¹⁾_{PUCCH}=n_{CCE2}+N^{CC2}_{PUCCH}+N⁽¹⁾_{PUCCH}.

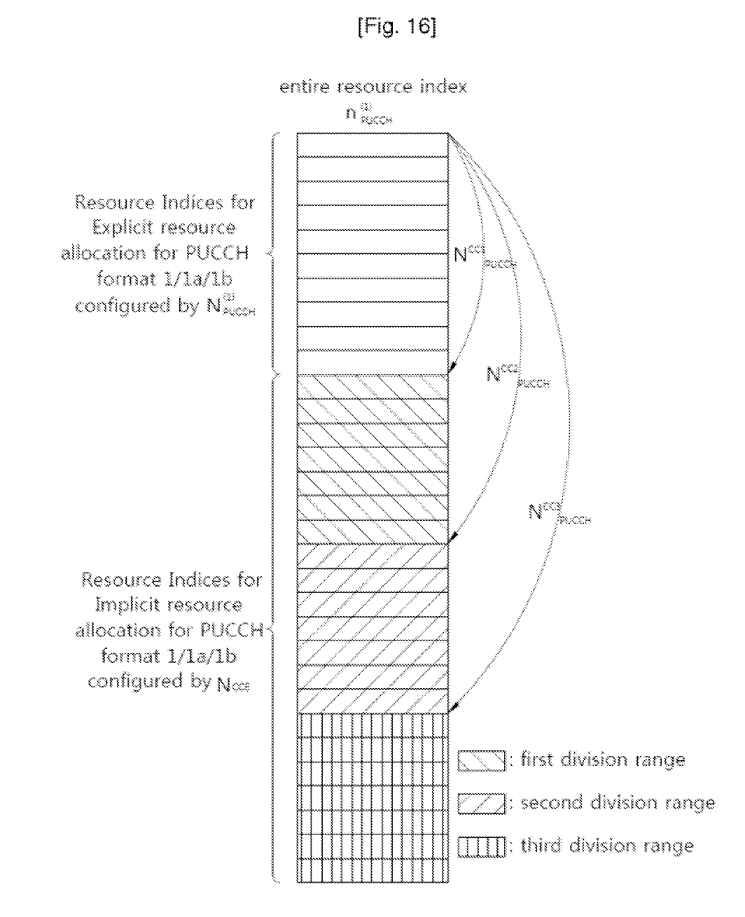

Also, the BS transmits PDCCH3 and PDSCH 3 indicated by the PDCCH3 on DL CC3 in the first subframe (S1510). In order to allow only resource index of a third division range to be allocated with respect to DL CC3, the MS uses n′_{CCE3}=n_{CCE3}+N^{CC3}_{PUCCH} obtained by adding a division offset N^{CC3}_{PUCCH} to n_{CCE3}, to calculate a resource index. Here, the resource index is n⁽¹⁾_{PUCCH}=n_{CCE3}+N^{CC3}_{PUCCH}+N⁽¹⁾_{PUCCH}. In this manner, resource indices of respective DL CCs allocated by the divisional resource allocation may be schematized as illustrated in FIG. 16.

Referring back to FIG. 15, the MS allocates resource indices n⁽¹⁾_{PUCCH1}, n⁽¹⁾_{PUCCH2}, and n⁽¹⁾_{PUCCH3} with respect to PUCCH1, PUCCH2, and PUCCH3, respectively (S1515). The MS determines a resource block, a cyclic shift, and an orthogonal sequence based on the corresponding resource indices (S1520). Thereafter, the MS transmits ACK/NACK signals 1, 2, and 3 to the BS by using the resource block, the cyclic shift, and the orthogonal sequence (S1525).

Since the limited resource indices are divided into division ranges and allocated as resources of PUCCHs with respect to the entire DL CCs, resource collision can be eliminated, while there may be a trade-off as resource shortage occurs.

In FIGS. 15 and 16, it has been described on the assumption that there are three DL CCs, but it is merely illustrative and when there are five DL CCs, there are five division ranges, and accordingly, there are five division offsets.

So far, the implicit resource allocation, explicit resource allocation, hybrid resource allocation, implicit resource allocation according to renumbering, and divisional resource allocation have been described and advantages and disadvantages of the respective resource allocation schemes have been described. The respective resource allocation schemes may be independently applied or two or three types of resource allocation schemes may be combined to be simultaneously applied. FIG. 10 shows a case in which only the hybrid resource allocation is applied, FIG. 12 shows a case in which only the implicit resource allocation according to renumbering is applied, and FIG. 14 shows a case in which both the implicit resource allocation according to renumbering and the explicit resource allocation are simultaneously applied. Also, FIG. 15 shows a case in which only the divisional resource allocation is applied. These embodiments show that various resource allocation schemes may be combined to be applied, and the present invention is not limited thereto and resource allocation schemes based on any combinations may be applicable.

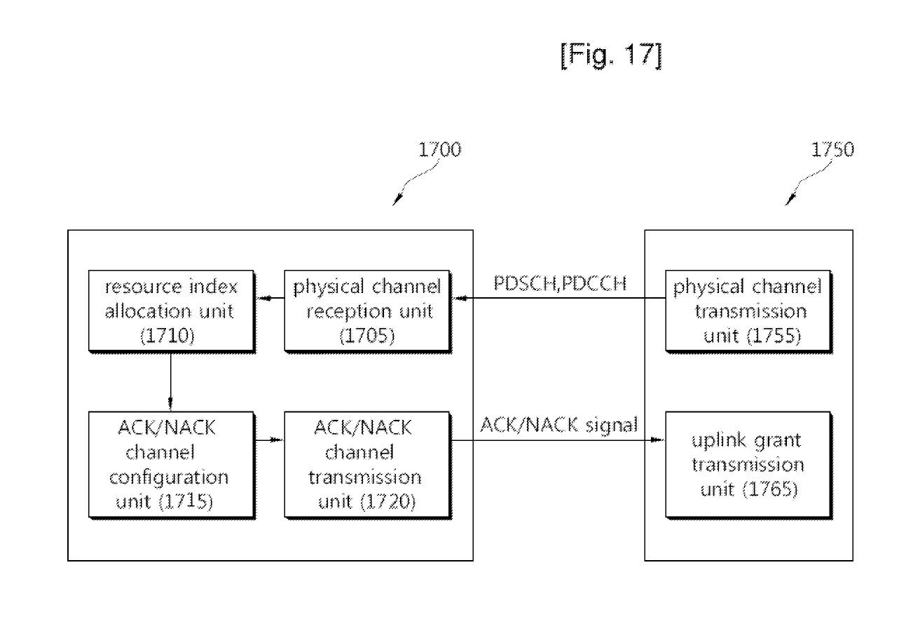

FIG. 17 is a block diagram illustrating a transmission device and a reception device of an ACK/NACK signal in the multi-component carrier system according to an embodiment of the present invention.

Referring to FIG. 17, an ACK/NACK signal transmission device 1700 includes a physical reception unit 1705, a resource index allocation unit 1710, an ACK/NACK channel configuration unit 1715, and an ACK/NACK channel transmission unit 1720. The ACK/NACK signal transmission device 1700 may be part of a mobile station. The ACK/NACK signal transmission device 1700 transmits an ACK/NACK signal with respect to a plurality of DL CCs by using one UL CC. Thus, although a plurality of DL CCs are set, a resource index of a PUCCH provided in one UL CC should be used.

The physical channel reception unit 1705 receives a PDCCH and a PDSCH indicated by the PDCCH from a reception device 1750 of the ACK/NACK signal. Meanwhile, when a plurality of CCs are set, the physical channel reception unit 1705 may receive a PDCCH and a PDSCH from each CC.

The resource index allocation unit 1710 allocates a resource index of a PUCCH corresponding to a PDSCH of each DL CC. Here, the resource index allocation unit 1710 selects a particular resource allocation scheme and allocates the resource index based on the selected particular resource allocation scheme.

For example, the resource index allocation unit 1710 may allocate a resource index of a PUCCH corresponding to a PDSCH of each DL CC according to an implicit resource allocation scheme according to renumbering. In this case, the resource index allocation unit 1710 may calculate a resource index n⁽¹⁾_{PUCCH} based on n_{CCE} corresponding to a first number among CCEs used for the PDCCH and a renumbering offset (n_{offset}) for renumbering the n_{CCE}, and allocate the calculated resource index to the PUCCH. The resource index allocation unit 1710 performs the foregoing allocation to each DL CC in the same manner. In this case, however, a different renumbering offset value is set in each DL CC.

In another example, the resource index allocation unit 1710 may allocate a resource index of a PUCCH corresponding to a PDSCH of each DL CC according to a hybrid resource allocation scheme. For example, the resource index allocation unit 1710 may apply an implicit resource allocation with respect to at least one DL CC and apply an explicit resource allocation with respect to at least one different DL CC. In this case, the ACK/NACK signal transmission device 1700 should receive n⁽¹⁾_{PUCCH} through higher layer signaling for an explicit resource allocation from an ACK/NACK signal reception device 1750.

In another example, the resource index allocation unit 1710 may allocate a resource index of a PUCCH corresponding to a PDSCH of each DL CC according to a divisional resource allocation scheme. For example, the resource index allocation unit 1710 may limit a resource index range of a PUCCH that may be used by each DL CC. For example, the resource index allocation unit 1710 allocates a PUCCH resource index to each DL CC1 within 0˜50 as a first division range, and allocates a PUCCH resource index to each DL CC2 within 51˜100 as a second division range. Each division range may be calculated by N^{CC}_{PUCCH} given by higher layer signaling.

The ACK/NACK channel configuration unit 1715 determines a resource block, a cyclic shift, and an orthogonal sequence based on a resource index allocated by the resource index allocation unit 1710, and configures an ACK/NACK channel by using them.

The ACK/NACK channel transmission unit 1720 transmits an ACK/NACK channel configured by the ACK/NACK channel configuration unit 1715 to the ACK/NACK signal reception device 1750 through a particular UL CC.

The ACK/NACK signal reception device 1750 includes a physical channel transmission unit 1755 and an ACK/NACK channel reception unit 1760. The ACK/NACK signal reception device 1750 may be part of a base station.

The physical channel transmission unit 1755 transmits a physical channel such as a PDSCH or a PDCCH to the ACK/NACK signal transmission device 1700.

The ACK/NACK channel reception unit 1760 receives an ACK/NACK signal from the ACK/NACK signal transmission device 1700.

The present invention may be implemented by hardware, software, or a combination thereof. For hardware implementation, the present invention described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units, or a combination thereof. For software implementation, the present invention may be implemented by a module performing the foregoing functions. Software may be stored in a memory unit and executed by a processor. As the memory unit or the processor, various means well known to a person skilled in the art may be employed.

While the present invention has been shown and described in connection with the embodiments, it will be apparent to those skilled in the art that modifications and variations can be made without departing from the spirit and scope of the invention. Thus, the present invention is not limited to the foregoing embodiments and may include all the embodiments within the scope of the appended claims.

1. A method for transmitting control information by a mobile station in a multi-component carrier system, the method comprising:
receiving, on a component carrier, a physical downlink control channel explicitly indicating a resource index of a physical uplink control channel;
receiving, on the component carrier, a physical downlink shared channel indicated by the physical downlink control channel;
calculating a cyclically shifted sequence and an orthogonal sequence based on the resource index;
spreading an ACK/NACK signal indicating a successful reception or unsuccessful reception of the physical downlink shared channel by the cyclically shifted sequence and the orthogonal sequence;
mapping the spread ACK/NACK signal to the physical uplink control channel; and
transmitting the physical uplink control channel to a base station.

2. The method of claim 1, wherein the resource index is a value specific to the component carrier, and is exclusively allocated with respect to a resource index of a different component carrier.

3. The method of claim 1, wherein the cyclically shifted sequence is obtained by cyclically shifting a base sequence by a particular cyclic shift amount.

4. The method of claim 1, wherein the ACK/NACK signal is mapped to four single carrier (SC)-frequency division multiple access (FDMA) symbols and transmitted.

5. A method for receiving control information by a base station in a multi-component carrier system, the method comprising:
transmitting, on a component carrier, a physical downlink control channel explicitly indicating a resource index of a physical uplink control channel to a mobile station;
transmitting, on the component carrier, a physical downlink shared channel indicated by the physical downlink control channel to the mobile station; and
receiving the physical uplink control channel from the mobile station,
wherein an ACK/NACK signal indicating whether the physical downlink shared channel has been successfully or unsuccessfully received is mapped to the physical uplink control channel, and the ACK/NACK signal is spread by a cyclically shifted sequence and an orthogonal sequence calculated based on the resource index.

6. The method of claim 5, wherein the resource index is a value specific to the component carrier, and is exclusively allocated with respect to a resource index of a different component carrier.

7. The method of claim 5, wherein the cyclically shifted sequence is obtained by cyclically shifting a base sequence by a particular cyclic shift amount.

8. The method of claim 5, wherein the ACK/NACK signal is mapped to four single carrier (SC)-frequency division multiple access (FDMA) symbols and transmitted.

9. A mobile station for transmitting control information in a multi-component carrier system, the mobile station comprising:
a physical channel reception unit configured to receive, on a component carrier, a physical downlink control channel explicitly indicating a resource index of a physical uplink control channel and to receive a physical downlink shared channel indicated by the physical downlink control channel;
a resource index allocation unit configured to allocate the resource index corresponding to the physical downlink common channel;
an ACK/NACK channel configuration unit configured to spread an ACK/NACK signal indicating whether the physical downlink shared channel has been successfully or unsuccessfully received, by a cyclically shifted sequence and an orthogonal sequence calculated based on the resource index; and
an ACK/NACK channel transmission unit configured to map the spread ACK/NACK signal to the physical uplink control channel and transmit the same.

10. The mobile station of claim 9, wherein the resource index allocation unit allocates the resource index as a specific value different from a resource index of a different component carrier.

11. The mobile station of claim 9, wherein the ACK/NACK channel configuration unit generates cyclically shifted sequence by cyclically shifting a base sequence by a particular cyclic shift amount.

12. The mobile station of claim 9, wherein the ACK/NACK channel transmission unit maps the spread ACK/NACK signal to four single carrier (SC)-frequency division multiple access (FDMA) symbols and transmits the same.
